(19) United States
(12) Patent Application Publication
(10) Pub. No.: US 2025/0167490 A1
(43) Pub. Date: May 22, 2025

(54) ROTATABLE SAFETY LOCKING SYSTEM FOR ELECTRICAL CONNECTOR

(71) Applicant: Aptiv Technologies AG, Schaffhausen (CH)

(72) Inventors: Romain SAVINA, Saint Martin de Bréthencourt (FR); Uvaraj GANESAN, Poonamallee (IN); Sylvain LOAS, Le Gault Saint Denis (FR); Laurent DELESCLUSE, SAINT-PIAT (FR); Gurusamy VIMALKANTH, Tamil Nadu (IN)

(21) Appl. No.: 18/953,854

(22) Filed: Nov. 20, 2024

(30) Foreign Application Priority Data
Nov. 21, 2023 (EP) 23211339.9

(51) Int. Cl. H01R 13/629; H01R 13/641; H01R 43/26

(52) U.S. Cl. CPC H01R 13/62955; H01R 13/641; H01R 43/26

(57) ABSTRACT

The disclosure presents a connector with a safety locking system (SLS) for secure mating and unmating with a counter-connector. The connector housing carries electrical terminals designed to establish contact with counter-terminals in the counter-connector through an insertion and extraction movement. The SLS features a rotatable locking edge that can be positioned in an unlocking state to allow extraction for unmating or a locking state to prevent extraction and maintain the connection. The SLS locking edge abuts against a surface of the counter-connector to secure the connection. This innovative connector design enhances safety and reliability in electrical connections.

### CROSS-REFERENCE TO RELATED APPLICATION

This application claims the benefit of and priority to European Patent Application No. 23211339.9 filed on Nov. 21, 2023, the contents of which are incorporated by reference herein.

### TECHNICAL FIELD

The disclosure generally relates to the field of connectors, in particular of electrical connectors for example within motor vehicles or mobiles systems, notably for connecting cables with only a few wires.

### BACKGROUND

Connectors are used to connect together several previously made elements, in order to make a connection between them that allows electrical energy and/or signals to be transmitted between these elements. These elements are mostly cables of one or several wires, or “harnesses” of several cables, or can each be a cable or a motor or another type of device such as a computer or a sensor or a lighting device. For clarity reasons, the term “cable” will be used here, but it should be understood that it may include other kinds of to-be-connected elements. According to the need, such connectors may have electrical contacts in greater or lesser number and in greater or lesser size.

When the connector mounted on one cable is mated with another connector, referred to herein as a counter-connector, usually of a different and complementary type, its electrical contacts are themselves mated with corresponding counter contacts on the other side of the connection that are mounted in the counter connector.

The connector and counter-connector are typically mated by inserting the housing of one into the housing of the other, usually with guiding features that also often include an error proofing feature. Often, both housings are then automatically retained together by an elastic latch at the end of insertion movement.

In order to make sure that mating of contacts is fully done, such connectors also often comprise a further mobile part called a “Connection Position Assurance” (CPA). Such CPA is arranged as a visible manual lock configured so as to prevent the connector and counter-connector from being separated and unmated, and that may be not fully moved and locked as long as the mating is not correct, and which position clearly shows if it is actually mated or not.

Still, a further kind of housing lock is sometimes added too, called a “Safety Locking System” (SLS), possibly also called “Security Locking System”, for providing a stronger mechanical link between connector and counter-connector, through a sliding part that may be manually engaged with both connector and counter-connector housings.

However, it is still desirable to enhance compactness of such a connector, to make it easier to design and more flexible to adapt to an existing model of counter-connector; to make it simpler and more ergonomic to manufacture, store and transport such connectors, to mount them on their cables, and to organize et operate their assembling and disassembling with their corresponding counter-connectors.

### SUMMARY

In some aspects, the techniques described herein relate to a connector, including: a connector housing including one or more electrical terminals, the connector configured to be mated with a counter-connector so as to obtain a contact connection of the electrical terminals with one or more counter-terminals disposed in a housing of the counter-connector, the mating including an insertion movement of a connector guiding part and a counter-connector guiding part within each other, the connector being arranged to be unmated from the counter-connector through an extraction movement of the connector guiding part and the counter-connector guiding part from each other; and a safety locking system (SLS) having an SLS locking edge, and which is rotatably movable between at least: an unlocking position configured to allow the extraction movement and thus allow an unmating of the terminals and the counter-terminals from each other and a locking position configured to prevent the extraction movement and thus prevent an unmating of the terminals and the counter-terminals from each other, through an abutment of the SLS locking edge with a surface of the counter-connector that is transverse to the extraction movement.

In some aspects, the techniques described herein relate to a method for manufacturing a connector, including: providing the connector including a housing and a safety locking system (SLS); inserting the SLS, in a translational movement preferably orthogonally oriented toward a mating insertion movement, into one or several insertion slots existing within the connector housing; continuing the translational movement until achieving a pivoting link between the SLS and the connector housing, by sliding and elastically snapping two pivots into to two pivoting holes borne by the SLS and the connector housing, respectively or reversely; and rotating the SLS into its unlocking position, thus sliding and elastically snapping one or several prelock latches into a position of abutment with a connector prelock shoulder of the connector housing so as to prevent a rotational movement of the SLS toward its locking position, and thus maintaining the connector ready for being mated by an insertion movement.

In some aspects, the techniques described herein relate to a method for mating/unmating a connector, including: providing the connector including a connector housing and a safety locking system (SLS) with its SLS in unlocking position; mating the connector with a counter-connector by inserting a connector guiding part and a counter-connector guiding part within each other, thus preferably sliding and elastically snapping at least one connector latch and one counter-connector latch within each other that prevent an extraction movement; and rotating the SLS into its locking position, thereby providing a supplementary safety in preventing unmating of the connector and the counter-connector from each other, such locking rotation preferably sliding and snapping within each other a latch and a locking edge that are borne by the SLS and the connector housing, respectively or reversely.

One aim of the SLS is to overcome some or all of the disadvantages presented above. In particular, it is intended to make the connector and its use more robust and more reliable, especially in some or all of the steps between its manufacture and its connection to its counter-connector.

These objectives are achieved partially or wholly, according to the disclosure, by a device and method having the features set forth in the claims. The claims form an integral part of the technical instruction provided herein in connection with the disclosure.

As is understood in view of the claims and the present disclosure, these features allow the connector to be designed with a better trade-off between compacity, form-factor, robustness and reliability, simplicity of manufacturing and using. For example, the locking system is less prone to be moved involuntary, either before mating or once mated and locked, and no or limited manual operations are needed for mating such connector and counter-connector.

With such shape of the SLS, it is achieved a connector that encompass such multiple functionalities while being compact, as well as ergonomically designed for fabrication and assembling.

Especially, there is no risk for the SLS to be accidentally moved into its locking position during transport or storage of the unmated connectors, which could require a manual unlocking prior to the normal mating operation for assembling operator.

Further, the sheer fact of mating the housings together is sufficient to automatically cancel this prelock latching, which is not anymore useful, and enable an operator to then directly rotate the SLS in its final locking position.

Risks of loss of time are thus minimized for the global operation of mating and securing together the connector with its counter-connector, and thus connecting together their respective cables.

Various embodiments of invention are hereby envisioned, which comprise the optional features here disclosed, according to all of their feasible combinations.

### BRIEF DESCRIPTION OF THE DRAWINGS

Other advantages and features will become apparent on examination of the detailed description of three examples, which are in no way limitative, and the attached drawings, in which:

FIG. 1a is a perspective view of the connector while receiving the safety locking system (SLS);

FIG. 1b is a perspective view of the safety locking system (SLS), alone and in the same orientation as in FIG. 1;

FIG. 2a is a perspective view of the connector with SLS once inserted and rotated into prelocking position;

FIG. 2b and FIG. 2c are detailed views of the SLS in its prelocking position in the connector housing, in a transverse cut A-A from FIG. 2a, respectively in perspective and in front view;

FIG. 3 is a lateral view of the SLS in prelocking position within the connector housing, in a sagittal cut C-C from FIG. 2c;

FIG. 4 is a perspective view of the connector and its counter-connector during their mating movement;

FIG. 5a and FIG. 5b illustrates, in a detailed top view of horizontal cut B-B, of the movement of the counter-connector guiding and its interaction with the SLS prelock latch;

FIG. 5c is a detailed view of a transverse cut through the SLS and its prelock latch, illustrating the action of the counter-connector guiding wall on the SLS prelock latch;

FIG. 6a and FIG. 6b illustrate the rotating of the SLS from its mating position toward its locking position;

FIG. 6c is a detailed lateral view of a sagittal cut C-C′, offset relatively to C-C, that illustrates the SLS in its locking position and its locking action on the counter-connector;

FIG. 7a to FIG. 7c detailed perspectives of the SLS, with the nearest connector wall removed, that illustrates:

FIG. 7a, the unlocking action on the SLS latch arm,

FIG. 7b and FIG. 7c, rotating the SLS towards its pre-locking and unlocking position, prior to unmating the connector and counter-connector from one another;

FIG. 8 is a perspective view that illustrates the unmating movement of connector and counter-connector from one another.

### DETAILED DESCRIPTION

A connector to be mated and unmated with a counter-connector through insertion and extraction movement is disclosed herein. The connector comprises a safety locking system, hereafter referred to as “SLS”, that bears a SLS locking edge and is rotatably movable around an axis perpendicular to insertion movement, between:
an unlocking position, allowing extraction movement, and.
a locking position, preventing the extraction movement an abutment of SLS locking edge with a counter-connector surface that is transverse to the extraction movement

The SLS has a “U” shape, with pivots on both wings that are inserted in connector housing transversally to the insertion movement. Wings have a prelocking latch, maintaining SLS in unlocking position until insertion movement M1, which automatically frees prelocking latch.

The SLS is retained in locking position by an elastic latch arm abutting against an internal face of the roof, preventing unlocking rotation of the SLS. The SLS is unlocked by back rotation enabled by pressing on latch arm.

FIGS. 1 to 3 illustrate several steps of operation for preparing for mating a connector 1 according to this example of embodiment. These steps are typically made before transporting it in bulk toward the place where it is to be used for mating it with its counter-connector 9, such as for assembling a vehicle-and before storing it in bulk.

In such embodiment, the connector 1 comprises a connector housing 1, which is here of a globally cylindrical shape with an axis “X” but could have other shapes. This connector housing 11 has an axially oriented receiving opening 110, which surround an elongated receiving core 15. This receiving core 15 also internally receives and support an electrical terminal 151 (or a group of several terminals), here of a female kind. The terminal(s) 151 is for example crimped on an electrical conductor of a cable 5, here axially extending from the opposite side (negative X) of the connector housing 11. In this example, the conductor and/or its terminal 151 has been inserted along direction X in the housing 11 and is fixed there in by a snap ring 155 laterally inserted through a lateral window of the connector housing 11.

On its external surface, here illustrated as direction “Z”, the connector receiving housing 110 extends radially and is closed by two parallel guiding walls 113 that are connected by a “SLS receiving” roof 123.

As an optional but preferred feature in this example, the connector 1 further comprises a Connection Position Assurance device 2 (“CPA”), possibly of a known kind, which is borne by the connector housing 11. Such CPA is mobile between at least an unconnected position and a connected position that present between them visible differences that are unambiguously significant. The CPA 2 is mechanically prevented to be moved from the unconnected position toward the connected position when the connector 1 is not fully connected with its counter-connector 9.

As seen enlarged in FIG. 1b, the SLS 3 has a global shape of an elongated plate bended into a “U”.

The bases of the U then form a central plate, here with an external non-slip surface, suitable for being manually pushed P31 as an actuation surface 35 by an operator when assembling and preparing the connector.

The two wings of the U are formed by two parallel plates substantially perpendicular to the central plate. Each wing plate has a first edge, facing toward right side of drawing in FIGS. 1a and b, and a second edge, facing toward left side of the same drawings.

Each wing of the SLS 3 bears on its external surface a cylindrical pivot 31 that orthogonally protrudes along a rotating axis A31 which is parallel to the central plate 35.

On the first edge of its free extremity, each wing bears an elastic elongated member that extends, parallel to the first edge, toward the bases of the “U” to form a latch branch 333. This latch branch bears a locking latch 34 on its face facing away from the wing. Both latch branches 333 are connected together, at their distal extremity, by a latch knob 331 that is parallel to and independent from the actuation surface 35. The branches 333 and knob 331 form together latch arm 33 that can be elastically bend toward the actuation surface 35 for retracting their locking latches 34.

The second edge of each wing of the SLS is arranged, on its distal extremity, with a corner called SLS locking edge 39 that will be able to receive an abutment from a counter-connector locking shoulder 9132.

On the same second edge, as an option embodied in the present example, each wing of the SLS 3 presents two partial cuts that delimit an elastic lug, which forms a prelocking arm 323 and externally bears a protrusion called prelocking latch 32.

As illustrated in FIG. 1a, the SLS is assembled with the housing 11 along a translational movement M0, orthogonally oriented toward the mating insertion movement M1, by inserting the two wings of the U into two insertion slots 139 that pass through the receiving roof 123 of the connector housing 11.

Upon the insertion movement M0, each of these SLS pivots 31 slides into a groove present in the guiding walls, until its pivot slope 311 pushes on and spreads a free extremity of an elastic arm 138 of the connector housing 11. When the SLS insertion M0 is achieved, elastic arms 138 and their pivoting holes 130 snap back around the wing pivots 31, thus achieving a rotation mobility of the SLS 3 around axis A31 in regard of the connector housing 11.

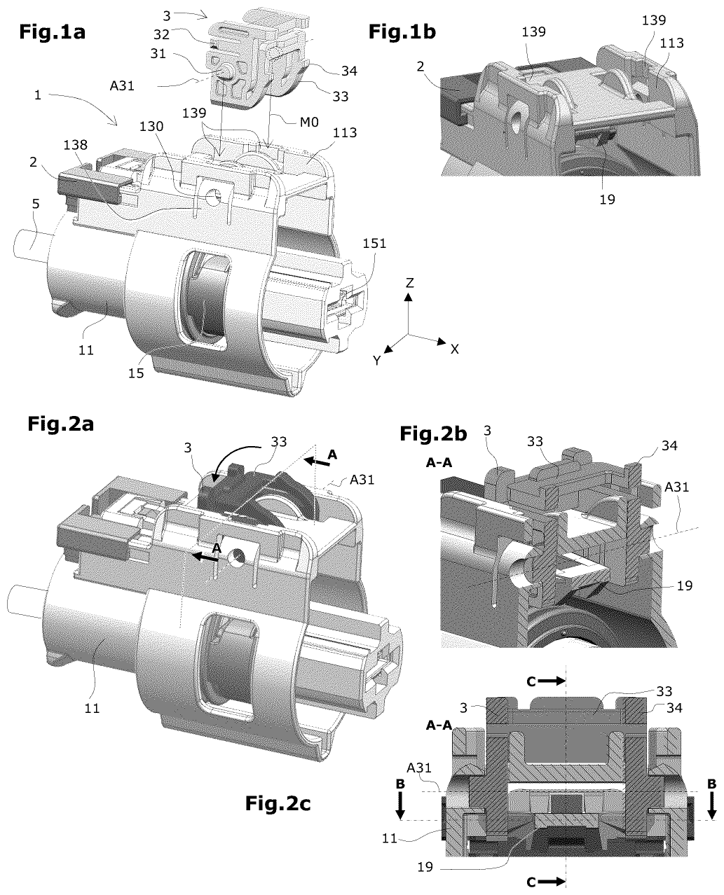

As illustrated in FIG. 2a, the SLS is then rotated R30 around its axis A31, by pushing on the edge of U bases 35 or on the locking arm 33, here of 90°. The SLS 3 is thus brought in a position called unlocking position, in which the connector 1 is ready for receiving its counter-connector 9. Along this preparation rotation R31, the prelock arms 323 are pushed and bent inward by a cam effect of a slope of their prelock latches 32, until the latter elastically snap behind prelock shoulders 1132 of the connector housing 11.

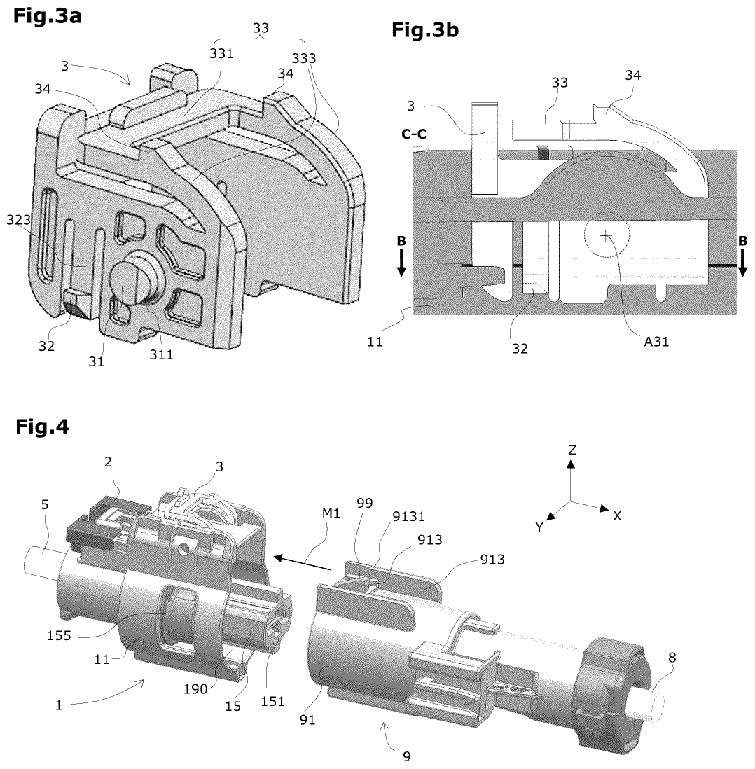

As illustrated in FIGS. 2b and c, the prelock latches 32 are now into a position of abutment against the prelock shoulder 1132, thus preventing the SLS 3 from leaving its unlocking position. It is thus made sure that all such connectors 1 will stay ready for future mating, whatever shocks or movements should occur such as during bulk storing or transport. Position of SLS 3 is also illustrated from another angle in FIG. 3, where abutment 1132 is not visible.

FIG. 4 to FIG. 6 illustrate several steps of operation for mating and locking together such connector 1 and counter-connector 9, according to this example of embodiment.

As illustrated in FIG. 4, the connector 1 is mated with the counter-connector 9 by inserting in a translational movement M1 the guiding parts of the connector and of the counter-connector 9 in one another.

Longitudinal skirt 910 of counter connector 9 slides into receiving opening 110 and around connector receiving core 15, and counter-connector guiding walls 913 slide in close contact between the guiding walls 113 of connector 1. Thereby, counter-terminal(s) (non-represented here) of counter-connector 9 engage in and mate with terminal(s) 151 of connector 1. Also, connector latch 19 slides against and is elastically deformed by fixed counter connector latch 99, and its opening snaps behind the counter connector latch 99, thus providing a first retaining function.

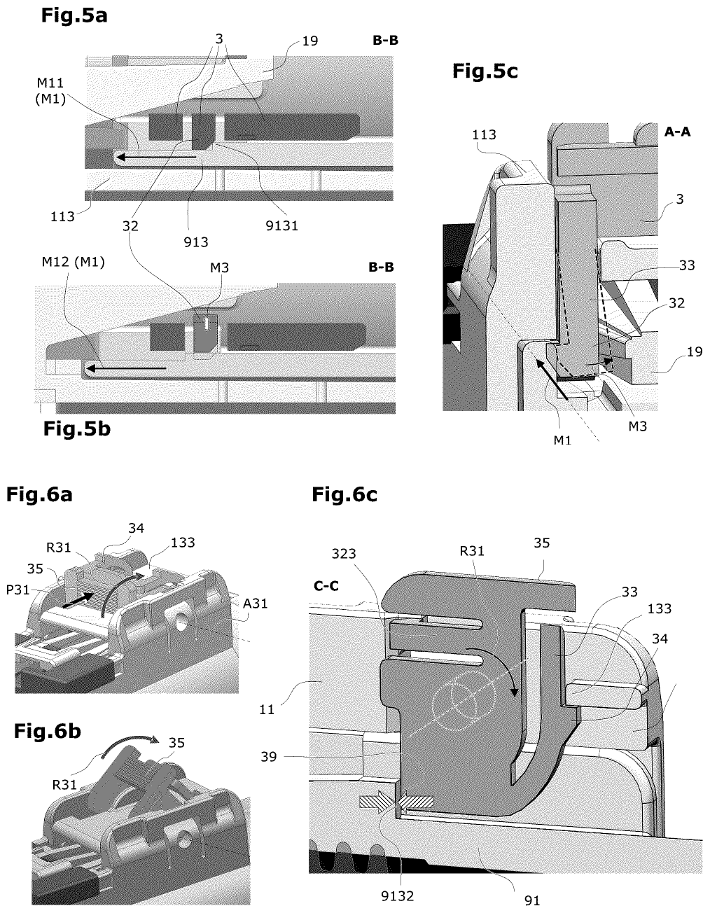

As illustrated in FIG. 5a to FIG. 5c, the insertion movement M1 does by itself release the prelock latches 32 from their abutment shoulder 1132 of the connector 1.

FIG. 5a shows a first part M11 of the insertion movement M1. AS can be seen, guiding wall 913 of counter-connector 9 has a sudden thickening that forms a shoulder 9131, which comes in contact with a slope of the prelock latch 32 of the SLS 3 when it is slidingly inserted along the connector guiding wall 113.

As illustrated in FIG. 5b and FIG. 5c, as counter-connector 9 continues his movement M1, in a second part M12, its shoulder 9131 then waives aside the prelock latch 32, in an inward elastically pivoting movement M32 (see arrows), through cam effect interaction with the slope thereof. As can be seen in dashed line in FIG. 5c, such waiving movement M32 (rotation rightward) causes a release of prelock latch 32 from its abutment with prelock shoulder 1132 of connector housing 11.

The prelock latch 32 is thus automatically released by the sole insertion movement M1, without any supplementary operation, thereby allowing the safety locking system 3 to be rotated out of its unlocking position.

As illustrated in FIG. 6a and FIG. 6b, once connector 1 and counter-connector 9 are fully inserted within each other, SLS 3 is then rotated R31 around axis A31 by manually pushing P31 on its actuation surface 35, here of 90°, until it reaches its locking position illustrated in FIG. 6c. On each wing of the SLS 3, this locking rotation R31 is stopped by the SLS locking edge 39 coming in abutment with a locking shoulder 9132 of the counter-connector guiding wall 913, here formed by a sudden variation of its transverse thickness.

During the same locking rotation R31, the SLS latching arm 33 is elastically pushed back by a connector locking edge 133 of the receiving roof 123 of the connector housing 11, through cam effect between the edge 133 and a slope of the SLS latches 34.

Once in locking position, as illustrated in FIG. 6c, SLS latches 34 snaps back behind the connector locking edge 133, which then provides an abutment with the latches 34 for preventing the SLS to rotate back.

As the safety locking system 3 is prevented from rotating back (i.e. counter-clockwise on FIG. 6c) by the connector housing 11, the abutment (see hatched arrows) between the SLS locking edge 39 and the counter-connector locking shoulder 9132 consequently prevents the counter-connector 9 and its guiding walls 913 to slide back away from the connector 1, and hence prevents it any disconnection.

In supplement to the first retaining function provided by the counter-connector latch 99 with the connector latch 19, this Security Locking System 3 (“SLS”) thus provides a second retaining function, that may backup the first one for example in case of a breaking of one of the latches 99 or 19.

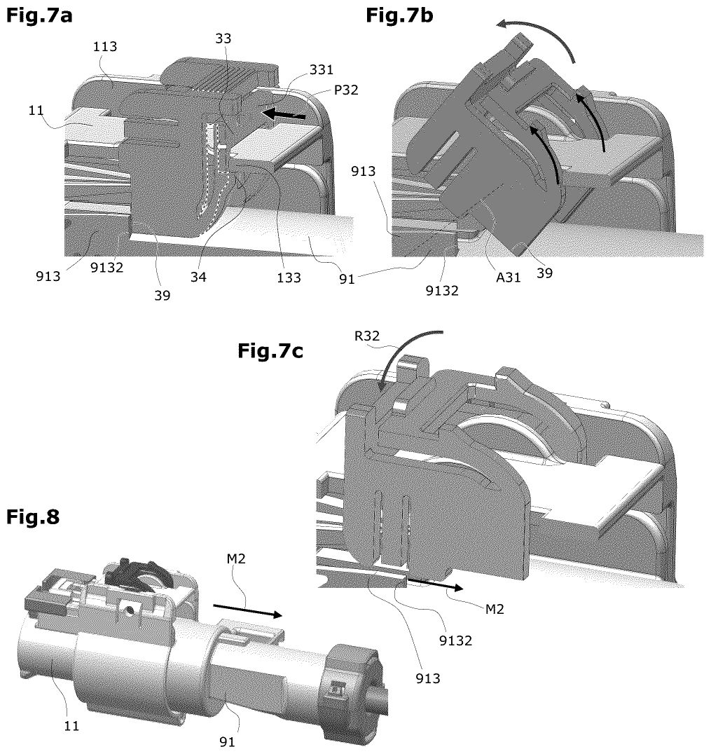

FIG. 7 to FIG. 8 illustrate several steps of operation for unlocking and unmating connector 1 and counter-connector 9 from each other according to this example of embodiment, for example in for servicing or repairing such a vehicle.

As illustrated in FIG. 7a, the latching arm 33 of the safety locking system 3 is elastically bent back by pushing P32 on its knob 331, possibly by manual operation, thus retracting the SLS latches 34 out of abutment with connector locking edge 133. Once the latches 34 are retracted from abutment, the latching branches 333 are able to pass the locking edge 133, and the same pushing P31 then causes the SLS 3 to rotate back R32 out of its locking position, as illustrated in FIG. 7b.

Once the unlocking rotation R32 is achieved, as illustrated in FIG. 7c, the SLS locking edge 39 is completely out of the way of the counter-connector locking shoulder 9132, which may then slide back M2 away from the connector 1. As illustrated in FIG. 8, it is then possible to pull the counter-connector 9 and its housing 91 away from the connector 1 and its housing 11, thus disconnecting them completely from each other.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector, comprising:
a connector housing comprising one or more electrical terminals, the connector configured to be mated with a counter-connector so as to obtain a contact connection of the electrical terminals with one or more counter-terminals disposed in a housing of the counter-connector, the mating including an insertion movement of a connector guiding part and a counter-connector guiding part within each other, the connector being arranged to be unmated from the counter-connector through an extraction movement of the connector guiding part and the counter-connector guiding part from each other; and
a safety locking system (SLS) having an SLS locking edge, and which is rotatably movable between at least: an unlocking position configured to allow the extraction movement and thus allow an unmating of the terminals and the counter-terminals from each other and a locking position configured to prevent the extraction movement and thus prevent an unmating of the terminals and the counter-terminals from each other, through an abutment of the SLS locking edge with a surface of the counter-connector that is transverse to the extraction movement.

2. The connector in accordance with claim 1, wherein the connector housing comprises a receiving roof arranged substantially perpendicular to its guiding walls, the SLS being pivotally mounted around a pivot axis that is parallel to the receiving roof, the SLS comprising a latch arm that bears one or several SLS latches which, by abutting against connector locking edge of an internal face of the receiving roof,, prevents the SLS from being rotated from its locking position, and in that the latch arm may be elastically moved by a manual operation so as to waive its SLS latches out of its abutment with the receiving roof, thus allowing the SLS to be rotated from its locking position and then allowing the counter-connector to be extracted from the connector.

3. The connector in accordance with claim 2, wherein the SLS comprises one or several prelock latches which are arranged for cooperating with the connector housing by surfaces abutment for preventing the SLS from being rotated toward its locking position when the SLS is in unlocking position and being unlatched by an unlatching edge of the counter-connector housing upon insertion movement, thus allowing the SLS to be rotated toward its locking position.

4. The connector in accordance with claim 3, wherein the prelock latches of the SLS are each borne by an elastic prelock latch arm of the SLS that extends substantially transversally toward the axis of the insertion movement, wherein each of the prelock latches have a shape that includes a slope arranged for cooperating by cam effect with the unlatching edge upon insertion movement so as to displace the prelock latch out of its abutment with the connector housing.

5. The connector in accordance with claim 4, wherein the SLS has a global shape of an elongated plate bent into a “U”, with a “U” bases being formed by a central plate arranged for being pushed as an actuation surface by an operator so as to manually rotate the SLS from its unlocking position toward its locking position, two “U” wings being formed by two parallel plates, each having a first edge and a second edge, arranged opposite to each other and substantially perpendicular to the central plate, wherein, when the SLS is in prelocking and unlocking position, bears on its external surface a pivot that protrudes along the rotating axis of the SLS, is arranged on a distal part of the second edge with a face or a corner that comes in abutment with a counter-connector locking shoulder when the SLS is in locking position, thus forming the SLS locking edge, presents on the second edge one or several partial cuts that delimit an elastic lug, which forms the prelocking arm and bears a protrusion producing the prelocking latch, bears, from the first edge of its free extremity, an elastic elongated member that extends toward the bases of the “U” to form a latch branch that bears a locking latch, both latch branches being connected by a latch knob that is parallel to and independent from the actuation surface, the branches and knob forming together the latch arm.

6. The connector in accordance with claim 5, wherein the latch arm comprises two latch branches that each bears a SLS latch and are connected by a latch knob.

7. The connector in accordance with claim 6, wherein the two latch branches are arranged parallel to each other.

8. The connector in accordance with claim 1, further comprising a connection position assurance device (CPA) which is borne by the connector housing and is movable between at least an unconnected position and a connected position that present between them visible differences that are unambiguously significant, wherein the CPA is mechanically prevented to be moved from the unlocked position toward the connected position when the connector is not fully connected with its counter-connector.

9. The connector in accordance with claim 1, further comprising:
a counter-connector arranged for being mated and locked with it, wherein the guiding part of the counter-connector comprises one or several guiding walls, longitudinal to the insertion and extraction movements and that extend from an outside of the counter-connector housing, wherein the guiding part of the connector comprises a guiding wall that is arranged longitudinally to the insertion and extraction movements and extend from the outside of the connector housing, wherein the guiding wall is arranged for receiving and laterally guiding the counter-connector guiding part during the insertion and extraction movements, wherein the rotating movement of the SLS toward its locking position brings its SLS locking edge from an unlocking position in which the SLS locking edge is out of the way of the counter-connector guiding walls extraction movement; toward a locking position where: it is oriented against a direction of the extraction movement, and provides the locking abutment by coming face to face with a counter-connector locking shoulder, that protrudes from the counter-connector guiding wall and is oriented toward the direction of the extraction movement.

10. The connector in accordance with claim 9, wherein the guiding part of the connector comprises two guiding walls.

11. The connector in accordance with claim 9, wherein the counter-connector locking shoulder is formed by a sharp variation of a thickness of its guiding wall.

12. A method for manufacturing a connector, comprising:
providing the connector comprising a housing and a safety locking system (SLS);
inserting the SLS, in a translational movement preferably orthogonally oriented toward a mating insertion movement, into one or several insertion slots existing within the connector housing;
continuing the translational movement until achieving a pivoting link between the SLS and the connector housing, by sliding and elastically snapping two pivots into to two pivoting holes borne by the SLS and the connector housing, respectively or reversely; and
rotating the SLS into its unlocking position, thus sliding and elastically snapping one or several prelock latches into a position of abutment with a connector prelock shoulder of the connector housing so as to prevent a rotational movement of the SLS toward its locking position, and thus maintaining the connector ready for being mated by an insertion movement.

13. A method for mating/unmating a connector, comprising:
providing the connector comprising a connector housing and a safety locking system (SLS) with its SLS in unlocking position;
mating the connector with a counter-connector by inserting a connector guiding part and a counter-connector guiding part within each other, thus preferably sliding and elastically snapping at least one connector latch and one counter-connector latch within each other that prevent an extraction movement; and
rotating the SLS into its locking position, thereby providing a supplementary safety in preventing unmating of the connector and the counter-connector from each other, such locking rotation preferably sliding and snapping within each other a latch and a locking edge that are borne by the SLS and the connector housing, respectively or reversely.

14. The method in accordance with claim 13, further comprising:
providing the connector and its counter-connector mated and locked by the SLS in locking position;
pushing on a latching arm of the SLS so as to free it from the connector locking edge;
rotating the SLS from its locking position toward its unlocking position; and
extracting the connector and the counter-connector from each other.
